(19) United States
(12) Patent Application Publication
(10) Pub. No.: US 2006/0091773 A1
(43) Pub. Date: May 4, 2006

(54) Plasma display device

(76) Inventors: Sok-San Kim, Suwon-si (KR); Dong-Hwan Kim, Suwon-si (KR)

Correspondence Address: Robert E. Bushnell, Suite 300, 1522 K Street, N.W., Washington, DC, 20005-1202, US

(21) Appl. No.: 11/251,849

(22) Filed: Oct. 18, 2005

(30) Foreign Application Priority Data
Nov. 3, 2004 (KR) 10-2004-0088855

(51) Int. Cl. H01J 1/18

(52) U.S. Cl. 313/238

(57) ABSTRACT

A plasma display device includes: a Plasma Display Panel (PDP) adapted to display an image; a chassis base attached to a rear surface of the PDP; and a buffer member arranged between the PDP and the chassis base.

### CLAIM OF PRIORITY

This application makes reference to, incorporates the same herein, and claims all benefits accruing under 35 U.S.C. §119 from an application for PLASMA DISPLAY DEVICE earlier filed in the Korean Intellectual Property Office on the 3 of Nov., 2004 and there duly assigned Serial No.10-2004-0088855.

### BACKGROUND OF THE INVENTION

1. Field of the Invention

The present invention relates to a plasma display device, and more particularly, to a plasma display device capable of reducing vibration and noise.

2. Description of the Related Art

A plasma display device is a flat panel display device that displays images using a gas discharge phenomenon, and is highlighted as a next generation flat panel display that can substitute for a Cathode Ray Tube (CRT) since it has excellent display characteristics such as display capacity, brightness, contrast, residual image, and viewing angle.

The plasma display device includes a Plasma Display Panel (PDP) for displaying an image, and a chassis base including a circuit unit for driving the PDP installed on a back surface thereof. The PDP and the chassis base are received in a cabinet.

The PDP is attached to the chassis base and is received in the cabinet. In addition, the chassis base is formed of aluminum having a high thermal conductivity in order to dissipate heat generated by the PDP, and has a predetermined degree of rigidity so as to support the PDP with respect to the case. A circuit board, on which various electronic elements are mounted, is attached to the chassis base.

The plasma display device having the above structure displays the image using a plasma discharge of the PDP, and when the discharge continues, vibration and noise are generated.

In addition, since the chassis base and the PDP are attached to each other, vibration and noise generated from various electronic elements for driving the PDP and various cooling devices for cooling the display panel cause other vibration and noise that is transmitted to the PDP.

The noise of a plasma display device of good quality is about 40˜50 dB at a point 1 cm apart from a noise measurement point in a ⅓ octave band, and the noise of a defective device is about 60 dB. In addition, the noise at upper and lower edges of the panel is louder than the noise generated at a center portion of the panel, and vibration becomes severe at the portion where the noise is louder. Thus, the noise and vibration largely interrelate with each other.

### SUMMARY OF THE INVENTION

The present invention provides a plasma display device capable of reducing noise and vibration.

According to an aspect of the present invention, a plasma display device is provided including: a Plasma Display Panel (PDP) for displaying an image; a chassis base attached to a rear surface of the PDP; and a buffer member disposed between the PDP and the chassis base.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an exploded perspective view of a plasma display device according to an embodiment of the present invention;

FIG. 2 is an exploded perspective view of a part in the plasma display device of FIG. 1;

FIG. 3 is a cross-sectional view of the plasma display device taken along line I-I of FIG. 1;

FIGS. 4 through 7 are perspective views of modified examples of a chassis base of FIG. 1;

FIG. 8 is an exploded perspective view of a plasma display device according to another embodiment of the present invention;

FIG. 9 is a cross-sectional view of the plasma display device taken along line II-II of FIG. 8; and

FIGS. 10 through 13 are perspective views of modified examples of a chassis base of FIG. 8.

### DETAILED DESCRIPTION OF THE INVENTION

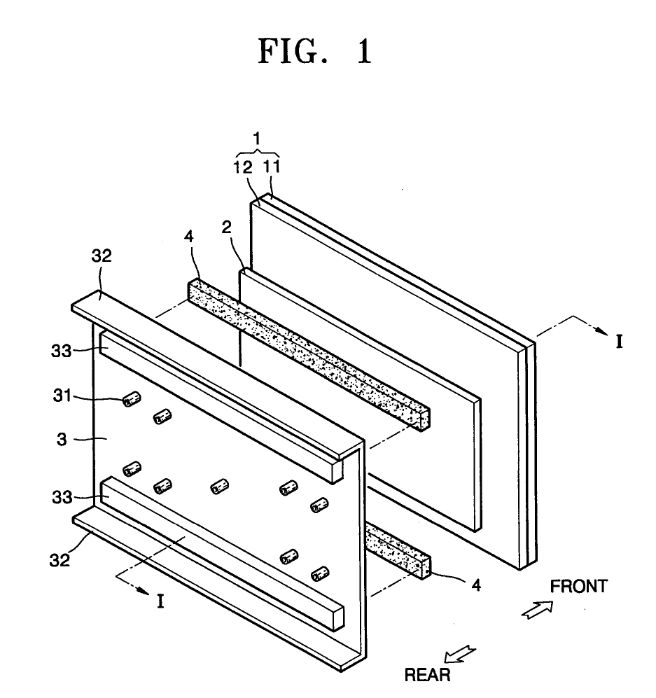

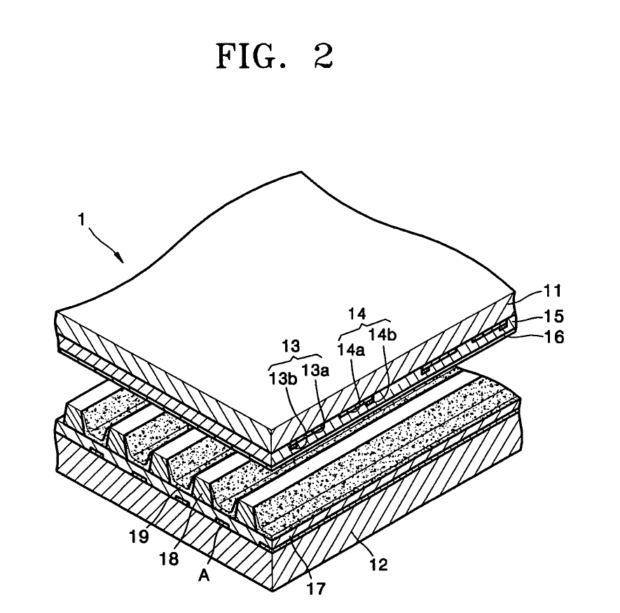

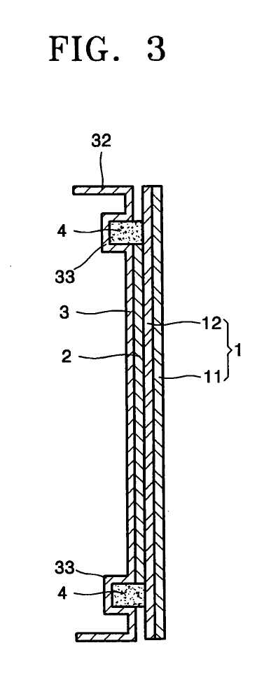

FIG. 1 is an exploded perspective view of a plasma display device according to an embodiment of the present invention, FIG. 2 is an exploded perspective view of a portion of the plasma display device of FIG. 1, and FIG. 3 is a cross-sectional view of the plasma display device taken along line I-I of FIG. 1.

Referring to FIG. 1, the plasma display device includes a PDP 1, and a chassis base 3 for fixing the panel 1 and providing the panel 1 with rigidity. The panel 1 and the chassis base 3 are received in a rear case (not shown), and a front case (not shown) is attached to the rear case from the front of the panel 1. A filter member (not shown) for shielding infrared rays and electromagnetic waves can be further disposed between the panel 1 and the front case.

Referring to FIG. 2, the PDP 1 included in the plasma display device according to the present invention includes a front substrate 11 and a rear substrate 12 facing each other. A discharge gas such as Ne or Xe is contained between the front and rear substrates 11 and 12, and a sealing material (not shown), such as frit glass, is applied on edges of the substrates 11 and 12 to seal and attach the substrates 11 and 12 together.

Address electrodes A formed in a predetermined pattern and a dielectric layer 17 are sequentially formed on the rear substrate 12, and barrier ribs 18 are formed on the dielectric layer 17 in order to maintain a discharge distance and to prevent electrical and optical cross talk from occurring between pixels. A phosphor layer 19 is formed on at least one surface of a discharge space defined by the barrier ribs 18.

A plurality of pairs including X electrodes 13 and Y electrodes 14 are formed in a predetermined pattern on the front substrate 11 attached to the rear substrate 12 to cross the address electrodes A. The X electrode 13 and Y electrode 14 respectively include transparent electrodes 13a and 14a and bus electrodes 13b and 14b. The X and Y electrodes 13 and 14 are sustain electrodes for generating a sustain discharge therebetween, and a cell is defined by the sustain electrodes and the address electrode A crossing each other.

A dielectric layer 15 embedding the X and Y electrodes 13 and 14 is formed on a lower surface of the front substrate 11, and an MgO layer 16 is formed on the dielectric layer 15. A gas is injected into the discharge space defined by the front and rear substrates 11 and 12.

In the PDP 1, when voltages are supplied to the address electrode A and one of the X and Y electrodes 13 and 14, an address discharge occurs between the electrodes to which the voltages are supplied, and charged particles are formed on a lower surface of the dielectric layer 15 of the front substrate 11 (more accurately, on a lower surface of the MgO layer). Then, a sustain discharge occurs on the surface of the dielectric layer 15 of the front substrate 11 when L a predetermined voltage is supplied between the X and Y electrodes 13 and 14 in the corresponding cell. The plasma is formed in the gas and ultraviolet rays are then generated to excite the phosphor material, thus forming a pixel.

In addition, black stripes formed of a black insulating material can be formed between the pairs of the X and Y electrodes 13 and 14 in order to improve a contrast in the PDP.

The PDP 1 described above is merely an example, and the present invention is not limited to the described structure. The present invention can be applied to all types of PDPs.

The chassis base 3 is installed on the rear substrate 12 of the PDP 1.

The chassis base 3 can be formed as a metal plate in order to fixedly support the PDP and dissipate the heat generated by the panel 1, and it is desirable for the chassis base 3 to be formed of an aluminum alloy. In addition, a heat dissipation sheet 2 formed of a thermally conductive material can be disposed between the chassis base 3 and the PDP 1 to improve the heat dissipation.

A plurality of bosses 31 are formed on a rear surface of the chassis base 3, and circuit boards (not shown) can be mounted onto the bosses 31. Various electronic elements (not shown) are mounted on the circuit boards to drive the PDP 1. In addition, a supporting portion 32 can be formed on edge of the chassis base 3, the supporting portion 32 supporting a Flexible Printed Circuit (FPC) extending from the PDP 1 when the FPC is connected to the circuit board (not shown) on the boss.

According to the present invention, a buffer member 4 can be further disposed between the chassis base 3 and the PDP 1. The buffer member 4 reduces noise and vibration generated by the plasma display device, and can be formed of a sound-absorbing material or a vibration-eliminating material.

The chassis base 3 includes receiving portions 33 to attach the buffer member 4 to the chassis base 3. The buffer member 4 is affixed to the receiving portion 33 with an adhesive or adhesive tape. However, the chassis base 3 and the PDP 1 can be attached to each other after receiving the buffer member 4 in the receiving portion 33, and the buffer member 4 is attached to the PDP 1 and does not escape out of the receiving portion 33.

Referring to FIG. 1, the receiving portion 33 can be bead shaped by pressing a predetermined portion of the chassis base 3.

When the buffer member 4 is affixed to the bead shaped receiving portion 33 and the chassis base 3 is then attached to the heat dissipation sheet 2 and the PDP 1, the cross-section of FIG. 3 can be obtained.

Referring to FIG. 3, the buffer member 4 is affixed to the bead shaped receiving portion 33 and the buffer member 4 contacts the rear surface of the PDP 1.

Therefore, the noise and vibration generated by the PDP 1 can be buffered by the buffer member 4. In addition, the noise and vibration generated by the chassis base 3 can be absorbed by the buffer member 4, and thus, the noise and vibration of the chassis base 3 are not transmitted to the PDP.

Referring to FIGS. 1 and 3, it is desirable for the receiving portions 33 receiving the buffer member 4 to be located at the edges of the chassis base 3, since the noise and vibration are generated more at the edge of the PDP 1 than at the center portion thereof.

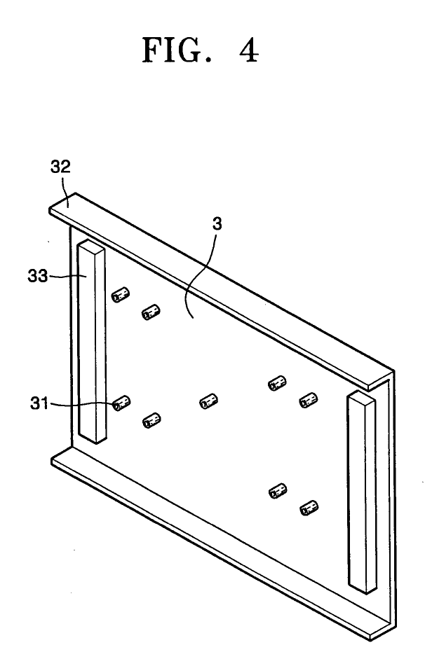

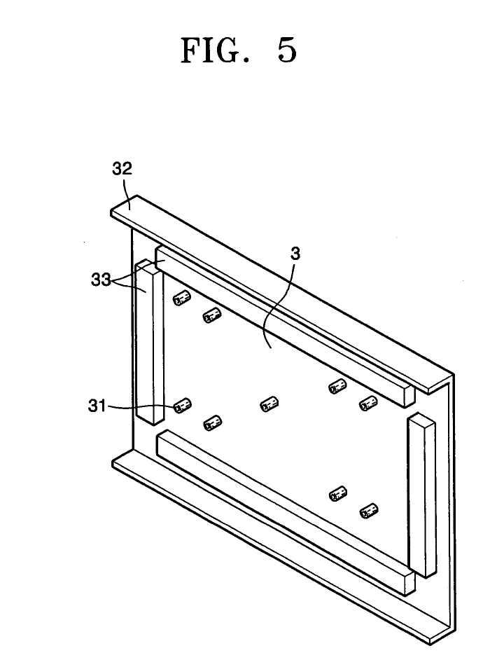

The receiving portions 33 can be formed on both edges of the chassis base 3 in a direction parallel to the ground by extending in a vertical direction with respect to the ground as shown in FIG. 4, or can be formed on the entire edge of the chassis base 3 as shown in FIG. 5.

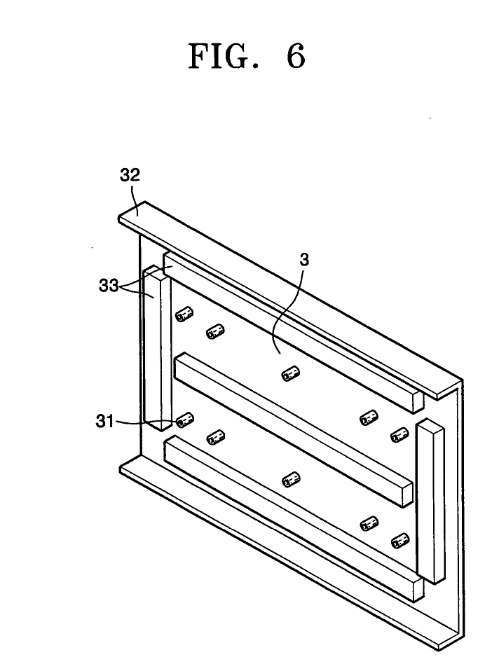

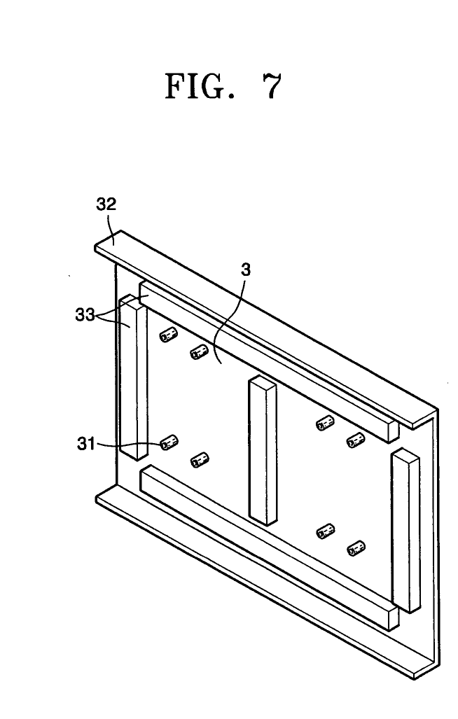

Moreover, besides the receiving portion 33 formed on the entire edge of the chassis base 3, an additional receiving portion can be formed at the center portion of the chassis base 3 in a direction parallel to the ground as shown in FIG. 6, or can be formed at the center portion of the chassis base in a direction parallel to the ground as shown in FIG. 7.

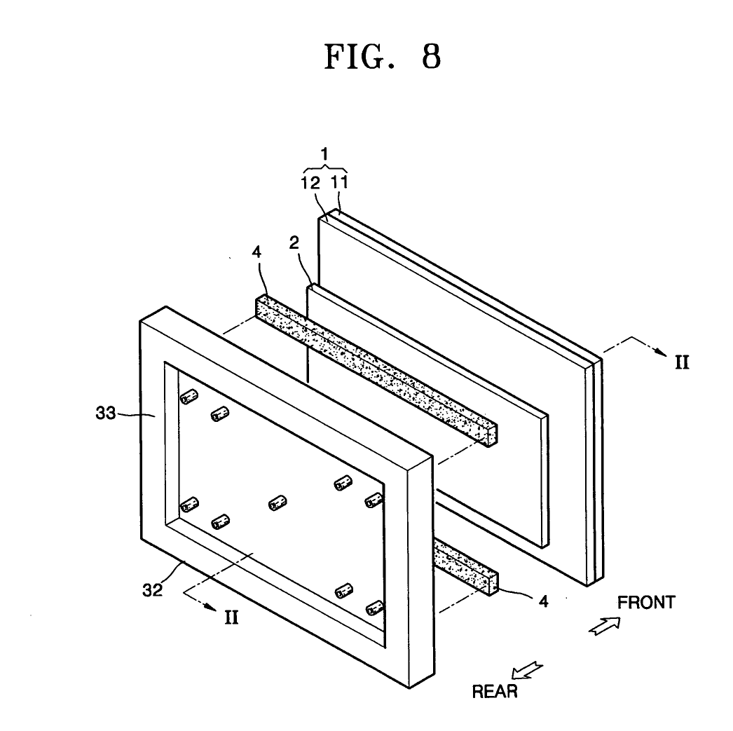

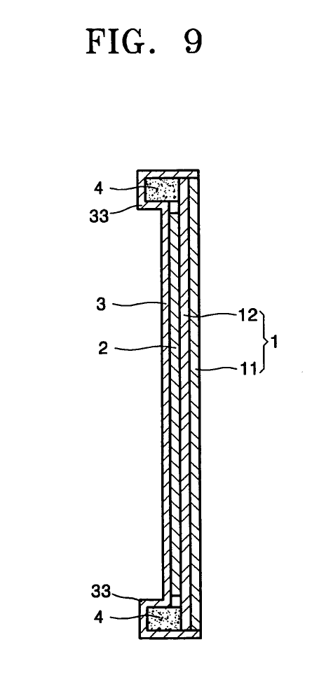

FIG. 8 is an exploded perspective view of a plasma display device according to another embodiment of the present invention, and FIG. 9 is a cross-sectional view of the plasma display device taken along line II-II after assembling the device of FIG. 8.

Referring to FIGS. 8 and 9, the receiving portion 33 for receiving the buffer member 4 can be extended along the edge of the chassis base 3 as a closed loop, and it can be formed in a drawing process using a press when molding the chassis base 3.

Referring to FIG. 9, the receiving portion 33 of the present embodiment does not require an additional supporting portion 32 of FIG. 1, and thus, the structure of the chassis base 3 can be compact.

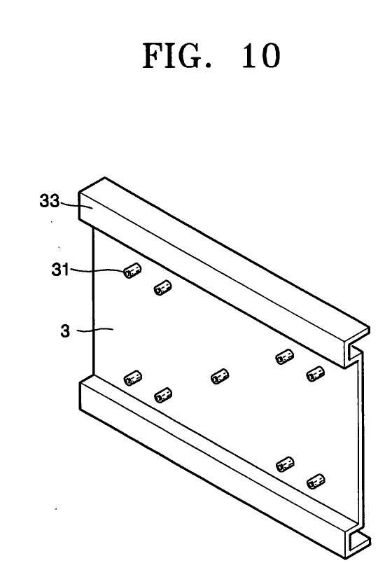

Besides the receiving portion 33 formed by the drawing on the entire edge of the chassis base shown in FIGS. 8 and 9, the receiving portion 33 can be formed on upper and lower edges of the chassis base 3 so as to extend in a direction parallel to the ground as shown in FIG. 10. Both ends of the receiving portion 33 are opened outward through left and right edges of the chassis base 3.

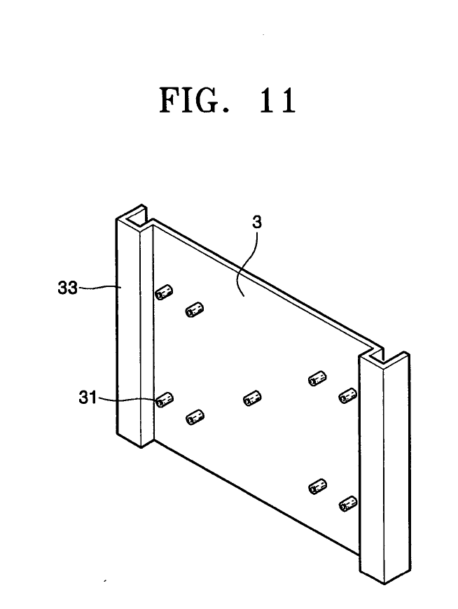

Referring to FIG. 11, the receiving portion 33 can be formed on left and right edges of the chassis base 3 so as to extend in a direction vertical to the ground. Both ends of the receiving portion 33 are also opened outward through the upper and lower edges of the chassis base 3.

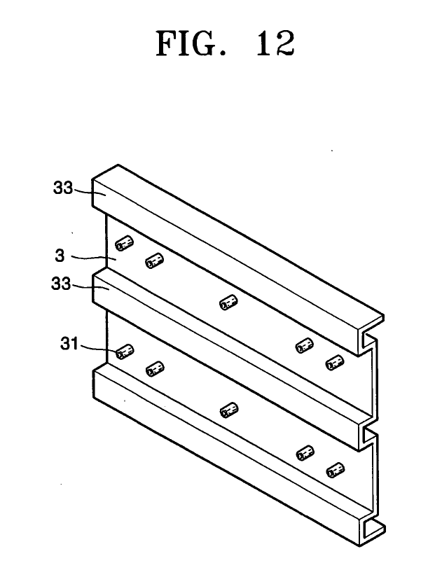

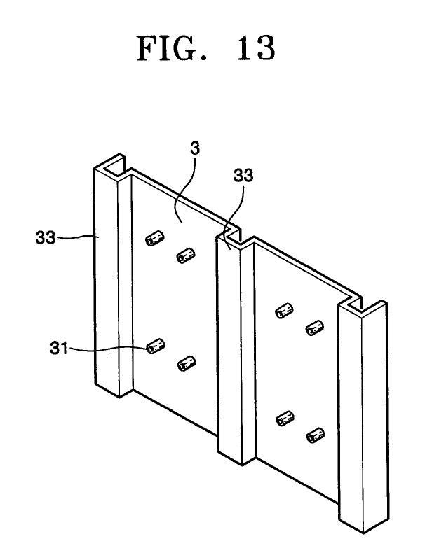

The receiving portion 33 can be formed on upper, middle, and lower portions of the chassis base 3 to extend in a direction parallel to the ground as shown in FIG. 12, or can be formed on left, middle, and right portions of the chassis base 3 to extend in a direction vertical to the ground as shown in FIG. 13.

The receiving portion 33 is not limited to the above examples.

In addition, the buffer member 4 is not necessarily attached to the receiving portion 33, but can formed to be thin like the heat dissipation sheet 2 and can be attached to a surface of the chassis base 3 facing the PDP 1 or to a surface of the PDP 1 facing the chassis base 3 without the receiving portion 33. The buffer member 4 is not limited to the above examples.

According to the present invention, the noise and vibration generated by the PDP 1 can be reduced by the buffer member 4.

In addition, the noise and vibration generated by the chassis base 3 can also be absorbed by the buffer member 4, so that the noise and vibration transmitted to the PDP 1 can be reduced.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A plasma display device, comprising:
a Plasma Display Panel (PDP) adapted to display an image;
a chassis base attached to a rear surface of the PDP; and
a buffer member arranged between the PDP and the chassis base.

2. The plasma display device of claim 1, wherein the buffer member is arranged to correspond to edges of the PDP.

3. The plasma display device of claim 1, wherein the buffer member is arranged to correspond to a center portion of the PDP.

4. The plasma display device of claim 1, wherein the buffer member is straight.

5. The plasma display device of claim 1, wherein the buffer member is a closed loop.

6. The plasma display device of claim 1, wherein the chassis base comprises at least one receiving portion, and the buffer member is adapted to be received in the at least one receiving portion.

7. The plasma display device of claim 6, wherein the receiving portion is arranged to correspond to the edges of the chassis base.

8. The plasma display device of claim 6, wherein the receiving portion is arranged to correspond to a center portion of the chassis base.

9. The plasma display device of claim 6, wherein the receiving portion is be straight.

10. The plasma display device of claim 6, wherein the receiving portion is a closed loop.

11. The plasma display device of claim 6, wherein end portions of the receiving portion are arranged inside of the edges of the chassis base.

12. The plasma display device of claim 6, wherein the end portions of the receiving portion are arranged to contact the edges of the chassis base.

13. The plasma display device of claim 1, wherein the buffer member is arranged to contact the PDP.

14. The plasma display device of claim 1, wherein the buffer member comprises at least one of a noise-absorbing material or a vibration-eliminating material.

15. The plasma display device of claim 1, further comprising a heat dissipation sheet arranged between the PDP and the chassis base.
